(19) United States
(12) Patent Application Publication
(10) Pub. No.: US 2022/0036659 A1
(43) Pub. Date: Feb. 3, 2022

(54) System and Method for Simulating an Immersive Three-Dimensional Virtual Reality Experience

(71) Applicants: R. Anthony Rothschild, London (GB); Sebastian Tobias Deyle, Berlin (DE)

(72) Inventors: R. Anthony Rothschild, London (GB); Sebastian Tobias Deyle, Berlin (DE)

(21) Appl. No.: 17/389,697

(22) Filed: Jul. 30, 2021

Related U.S. Application Data
(60) Provisional application No. 63/059,678, filed on Jul. 31, 2020.

(51) Int. Cl. G06T 19/00; G06T 19/20; G06T 3/00

(52) U.S. Cl. CPC G06T 19/006; G06T 19/20; G06F 3/16; G06T 2219/2012; G06T 2219/2021; G06T 3/0087

(57) ABSTRACT

The present invention brings concerts directly to the people by streaming, preferably, 360° videos played back on a virtual reality headset and, thus, creating an immersive experience, allowing users to enjoy a performance of their favorite band at home while sitting in the living room. In some cases, 360° video material may not be available for a specific concert and the system has to fall back to traditional two-dimensional (2D) video material. For such cases, the present invention takes the limited space of a conventional video screen and expands it to a much wider canvas, by expanding color patterns of the video into the surrounding space. The invention may further provide seamless blending of the 2D medium into a 3D space and additionally enhancing the space with computer-generated effects and virtual objects that directly respond to the user's biometric data and/or visual and acoustic stimuli extracted from the played video.

### BACKGROUND OF THE INVENTION

### 1. Field of the Invention

The present invention generally relates to an apparatus that plays back 360° videos on a virtual reality (VR) headset, thereby creating an immersive experience, allowing users to enjoy a performance of their favorite band at home while sitting in the living room. In cases where 360° video material is not available, the system can fall back to traditional two-dimensional (2D) video material, where the limited space of a conventional video screen is expanded to a much wider canvas by expanding color patterns of the video into the surrounding space. In certain embodiments, the present invention goes a step further by seamlessly blending the 2D medium into a three-dimensional (3D) space and additionally enhancing the space with computer-generated effects and virtual objects that directly respond to visual and acoustic stimuli extracted from the played video.

### 2. Description of Related Art

Today, movies and concerts, by way of example, are filmed in 3D, so that they can be viewed on a 3D viewing device (e.g., a VR headset, a 3D TV with 3D glasses, etc.). An example of 3D is provided in FIG. 2B where each object (204a, 204b, 204c) includes not only horizontal (X) and vertical (Y) components, but also a depth (Z) component. Typically as objects go further into the background of a 3D space 200b, they appear smaller, just as objects do in real life. In contrast, objects in 2D space only include horizontal (X) and vertical (Y) components, and do not include a depth (Z) component. See, e.g., FIG. 2A (showing an object 202 in a 2D space 200A).

With respect to the foregoing, there is a needed for a system and method for adding enhancements to video that was either captured or configured to be presented in 3D (3D video) or captured or configured to be presented in 2D (2D video), including videos (e.g., movies, concerts, sitcoms, etc.) that were captured using a single lens or camera. In particular, and especially with 2D video, there is an need to present previously recorded content, where other items are added to a 3D space surrounding the original content. The items may be unrelated to the original content, such as bursts of light, streams, or musical effects, or related to content (e.g., objects) appearing in the original content. It is further preferred that the objects presented in 3D space vary in color, texture, size, and/or movement.

Advantageously, the objects may be generated dynamically, whose movement and appearance are driven by audio-visual information extracted from the video and applied in sync with the current displayed video frame. To this end, visual-reactive effects mainly include color changes of virtual objects or textures. For example, the dominant color in the currently displayed video frame may be applied to the main light source in the virtual scene so that the virtual objects reflect light in a color corresponding to the content of the video. Likewise, video frames can be captured, down-scaled, blurred and added to the skydome texture, creating a shadow or echo-like effect that fills the whole background across the virtual space. Audio-reactive effects may include changes in color, size and pose, as well as velocity and direction changes and creation (spawn) events for particles. They can be driven by information extracted from the audio track of the played video, such as frequency spectrum, detected beat and onset events, pitch in form of the dominant frequency and overall volume.

### SUMMARY OF THE INVENTION

The present invention brings concerts directly to the people by streaming, preferably, 360° videos played back on a virtual reality (VR) headset and, thus, creating an immersive experience, allowing users to enjoy a performance of their favorite band at home while sitting in the living room. In some cases, however, 360° video material may not be available for a specific concert and the system has to fall back to traditional two-dimensional (2D) video material. For such cases, the present invention introduces an innovative approach to still provide a unique immersive, three-dimensional (3D) experience. The present invention takes the limited space of a conventional video screen and expands it to a much wider canvas, by expanding color patterns of the video into the surrounding space. However, the invention goes a step further by seamlessly blending the 2D medium into a 3D space and additionally enhancing the space with computer-generated effects and virtual objects that directly respond to visual and acoustic stimuli extracted from the played video. Hence, the 2D video fully integrates into a 3D space and is perceived as driving the virtual world around the user and bringing it to life.

In preferred embodiments of the present invention, an apparatus is configured to present a two-dimensional (2D) video within a three-dimensional (3D) space. In certain embodiments, the spatial context of the 3D space may be comprised of stationary and moving virtual objects. The 2D video may be rendered on a large flat virtual canvas positioned at a fixed location in front of the user wearing the head-mounted display (e.g., Virtual Reality (VR) headset which may or may not include headphones). Through use of the invention, previously recorded content (e.g., a concert) can be shown in its original 2D format, whereas other items are added to a 3D space surrounding the original content. The items may be unrelated to the 2D video, such as bursts of light, streams, or musical effects, or related to content (e.g., objects) appearing in the original content, such as stars. Obviously, these are merely examples of 3D objects and others are within the spirit and scope of the present invention. As discussed in greater detail below, the objects in 3D space, which may be 3D objects or 2D objects moving in a 3D space, may vary in color, texture, and/or size. The 3D space may also include items intended to center (or orient) the user in front of (or with respect to) the original 2D content, such as a couch in the user's living room, etc.

In certain embodiments, a panel (or area) may exist between the original content and 3D space, where the panel (or area) is configured to present 2D and/or 3D content and functions to soften the transition from the original content (e.g., 2D space) to the 3D immersive space. This softening can be accomplished by blending or blurring features that are (or appear to be) emanating from the 2D space. For example, if the 2D space is a heavy texture or color (e.g., dark purple), and the 3D space is a light texture or color (e.g., light purple), then panel may transition between the two using a medium texture or color (medium or mid-to-light purple). The objects presented in 3D space may either emanate from the 2D space and/or the 3D space, depending on various design constraints.

Visual-reactive effects mainly include color changes of virtual objects or textures. For example, the dominant color in the currently displayed video frame may be applied to the main light source in the virtual scene so that the virtual objects reflect light in a color corresponding to the content of the video. Likewise, video frames may be captured, down-scaled, blurred and added to the skydome texture, creating a shadow or echo-like effect that fills the whole background across the virtual space. The same technique can be applied on a panel extended from the edges of the video canvas and extruded into the space, causing an illusion of the video leaking over its edge and reaching into the space around it.

Audio-reactive effects include changes in color, size and pose, as well as velocity and direction changes and creation (spawn) events for particles. They can be driven by information extracted from the audio track of the played video, such as frequency spectrum, detected beat and onset events, pitch in form of the dominant frequency and overall volume, as described below. Space-filling floating particles initially move with constant speed in parallel direction towards the user. They respond to audio signals by changing their brightness and velocity with respect to the volume, resulting in flashing and pulsing movements with respect to the played music, which in turn causes the sensation of a pulsing movement of the user.

Other particles can be spawned when a certain threshold of volume of selected frequency was exceeded, or change their movement direction based on detected pitch. For example, frequency bars in the shape of rays may be positioned around the video canvas, each representing a fraction of the human perceivable frequency spectrum. Their length as well as brightness may be controlled by the intensity of the corresponding frequency extracted from the audio track. In a similar manner, frequency bars may be displayed on the platform under the user.

All of the above mentioned effects respond to visual and acoustic information derived from the video and audio track of the displayed video in order to integrate the video into the virtual world. The system is designed so that the effects originate from the video, such that the video content builds up the virtual world around the user. Realtime fusion of these effects assures a seamless blending of the 2D and 3D space.

The present invention achieves each of the above-stated objectives and overcomes the foregoing disadvantages and problems. These and other objectives and other features and advantages of the invention will be apparent from the detailed description, referring to the attached drawings, and from the claims. Thus, other aspects of the invention are described in the following disclosure and are within the ambit of the invention.

### BRIEF DESCRIPTION OF THE DRAWINGS

FIG. 1A depicts a Virtual Reality (VR) headset used in accordance with one embodiment of the present invention;

FIG. 1B illustrates the VR headset depicted in FIG. 1A when in use, placed on a user's head, with optional headphones;

FIGS. 2A and B depict a two-dimensional (2D) object presented in a 2D space and three-dimensional (3D) objects presented in a 3D space, respectively;

FIGS. 3, 4, and 9 illustrate embodiments of the present invention comprising a 3D space that includes a 2D space, where a 2D video is presented in the 2D space and 3D objects and/or video are presented in the 3D space;

FIG. 5 illustrates a system in accordance with one embodiment of the present invention that comprises the VR headset depicted in FIG. 1A and a plurality of computing devices in communication via a Wide Area Network (WAN);

FIG. 6 provides a block diagram of the host device depicted in FIG. 5 in accordance with one embodiment of the present invention;

FIG. 7 provides a block diagram of the set-top box depicted in FIG. 5 in accordance with one embodiment of the present invention;

FIG. 8 is a system in accordance with an alternate embodiment of the present invention where the VR headset is hardwired to at least one of the computing devices; and

FIG. 10 provides an overview of a pipeline to extract audio visual information in accordance with one embodiment of the present invention.

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description used herein is intended merely to facilitate an understanding of ways in which the embodiments herein may be practiced and to further enable those of skill in the art to practice the embodiments herein. Accordingly, the description or explanation should not be construed as limiting the scope of the embodiments herein.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown but is to be accorded the widest scope consistent with the claims.

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Referring to the drawings, wherein like numerals indicate like parts, to achieve the aforementioned general and specific objectives, the present invention generally comprises an apparatus configured to present a three-dimensional (3D) space comprising a two-dimensional (2D) space to a user, where the 2D space comprises a 2D video and the 3D space comprises at least one 2D and/or 3D object and/or video.

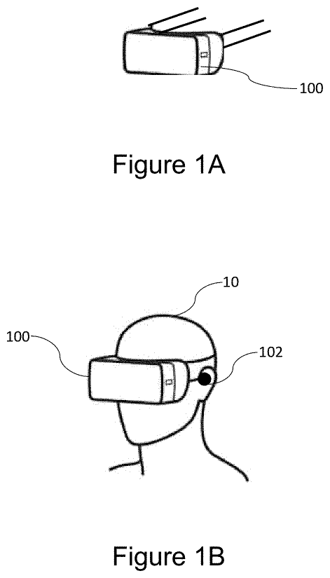

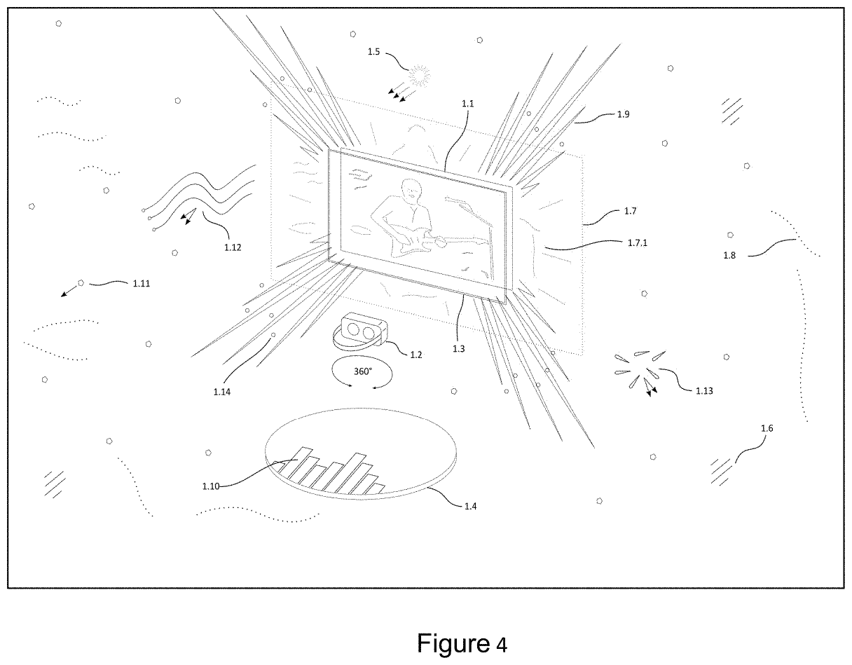

By way of example, FIG. 4 outlines one example of the present invention involving the integration of a 2D video into a 3D space, referred to herein as ConcertVR™. The spatial context of the virtual 3D space is comprised of stationary and moving virtual objects. The 2D video is rendered on a large flat virtual canvas (1.1) positioned at a fixed location in front of the user (1.2) wearing the head-mounted display. In one embodiment, this may include a Virtual Reality (VR) headset (see, e.g., FIG. 1A at 100), such as Oculus Quest™, Samsung VR Gear™, etc. As shown in FIG. 1B, the headset 100 and (preferably) corresponding headphones 102 (e.g., EarBuds™, AirPods™, Beats™, etc.) are preferably configured to be worn by a user 10, where the headset 100 provides video (2D, 3D, a mixture of the two in accordance with the present invention, etc.) and the headphones 102 provide audio, preferably stereo.

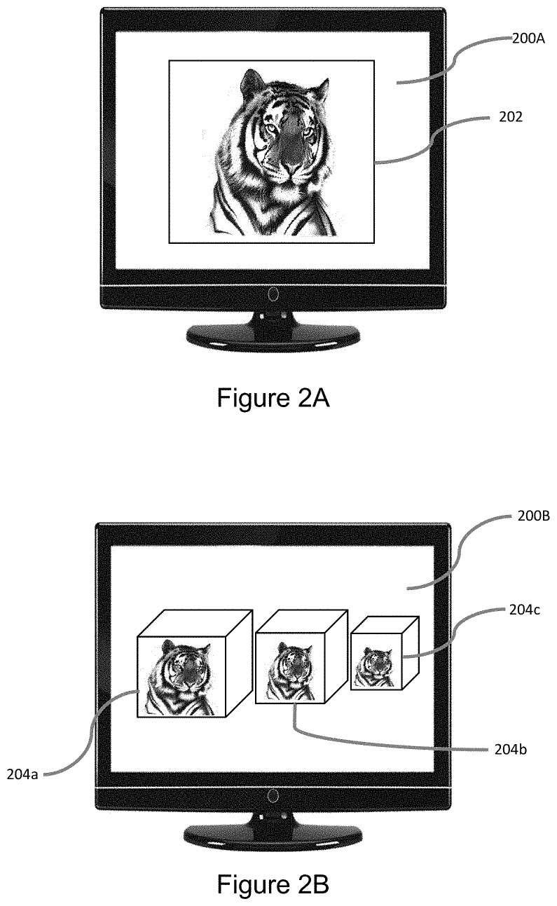

Today, movies and concerts, by way of example, are filmed in 3D, so that they can be viewed on a 3D viewing device (e.g., a VR headset, a 3D TV with 3D glasses, etc.). An example of 3D is provided in FIG. 2B where each object (204a, 204b, 204c) includes not only horizontal (X) and vertical (Y) components, but also a depth (Z) component. Typically as objects go further into the background of a 3D space 200b, they appear smaller, just as objects do in real life. In contrast, objects in 2D space only include horizontal (X) and vertical (Y) components, and do not include a depth (Z) component. See, e.g., FIG. 2A (showing an object 202 in a 2D space 200A). While the present invention can be used with video that was captured or configured to be presented in 3D (3D video) (e.g., adding enhancements to the 3D video based on changes in audio and/or video), it is most advantageous for video that was captured or configured to be presented in 2D (2D video), including videos (e.g., movies, concerts, sitcoms, etc.) that were captured using a single lens or camera.

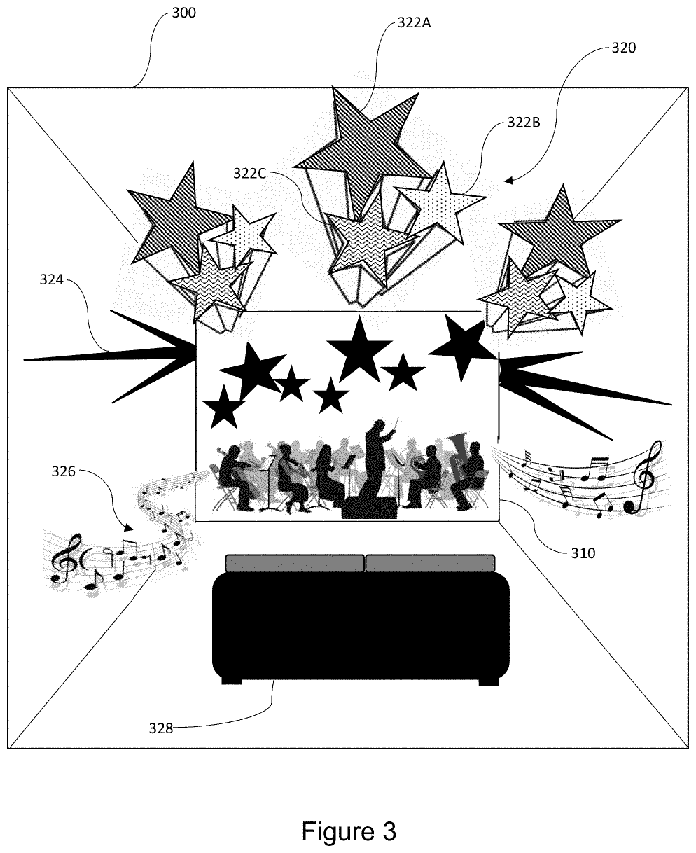

For example, as shown in FIG. 3, the previously recorded content 310 can be shown in its original 2D format, whereas other items are added to a 3D space 300 surrounding the original content 310. The items may be unrelated to the 2D video, such as bursts of light, streams, or musical effects (e.g., 324, 326), or related to content (e.g., objects) appearing in the original content, such as stars (322A, 322B, 322C). Obviously, these are merely examples of 3D objects and others are within the spirit and scope of the present invention. As discussed in greater detail below, the objects in 3D space, which may be 3D objects (not shown) or 2D objects moving in a 3D space (as shown), may vary in color, texture, and/or size. The 3D space 300 may also include items intended to center (or orient) the user in front of (or with respect to) the original 2D content, such as a couch 328 in the user's living room, etc. It should be appreciated that the term “pre-recorded” (or previously recorded), as used herein, is not limited to content that was recorded on a previous day, week, month, or year, and includes content that is essentially being performed live and streamed to the set-top box or VR headset, thereby resulting in a short delay (hence previously recorded) between the actual performance and its viewing by the user. It should also be appreciated that in certain embodiment, there is no previously recorded content (e.g., 310), only computer-generated content (e.g., 2D and/or 3D objects moving through 3D space), where the content is based on ambient and/or biometric data.

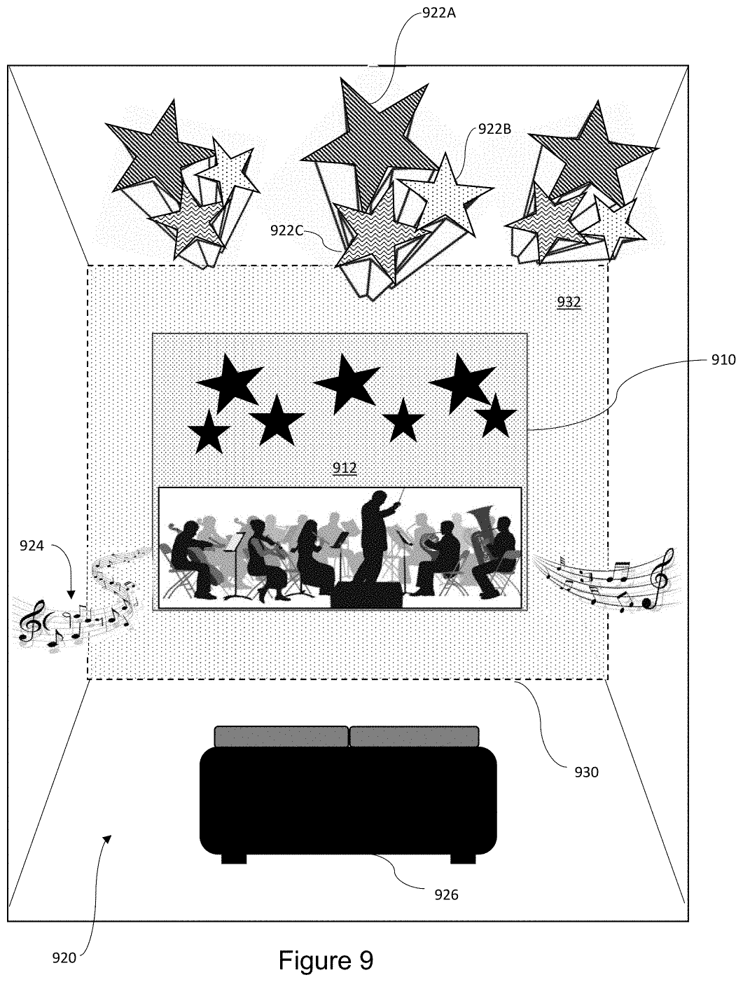

As shown in FIG. 9, a panel 930 (or area) may exist between the original content 910 and 3D space 920, where the panel 930 (or area) is configured to present 2D and/or 3D content and functions to soften the transition from the original content 910 (e.g., 2D space) to the 3D immersive space 920 (see discussion with respect to FIG. 3). This softening can be accomplished by blending or blurring features that are (or appear to be) emanating from the 2D space 910. For example, if the 2D space 910 is a heavy texture or color 912 (e.g., dark purple), and the 3D space 920 is a light texture or color (e.g., light purple), then panel 930 may transition between the two using a medium texture or color 932 (medium or mid-to-light purple). The objects presented in 3D space (e.g., 922A, 922B, 922C, 924) may either emanate from the 2D space and/or the 3D space, depending on various design constraints.

With reference back to FIG. 4, a 3D model (1.4) representing a platform in form of the ConcertVR™ logo is located below the user. Both provide a static reference frame for the user's body and help to orient within the virtual space. As discussed above, this can also be achieved with other objects (see, e.g., FIG. 3 at 328). A skydome rendered on the background (1.6) in all view directions creates an open wide space reaching beyond the walls of the user's living room, inducing a feeling of freedom and relaxation.

Dynamically generated visual effects, such as particles (1.11, 1.12, 1.13, 1.14), appear and gently float around the user and inhabit the space until they disappear again. Other virtual objects (1.3) that are used represent decor in the virtual environment may change in size and/or color. As discussed in greater detail below, their movement and appearance may be driven by audio-visual information extracted from the video and applied in sync with the currently displayed video frame.

Visual-reactive effects mainly include color changes of virtual objects or textures. For example, the dominant color in the currently displayed video frame is applied to the main light source (1.5) in the virtual scene so that the virtual objects reflect light in a color corresponding to the content of the video. Likewise, video frames are captured, down-scaled, blurred and added to the skydome texture (1.6), creating a shadow or echo-like effect (1.8) that fills the whole background across the virtual space. The same technique is applied on a panel (1.7) extended from the edges of the video canvas and extruded into the space, causing an illusion of the video leaking over its edge and reaching into the space around it (1.7.1).

Audio-reactive effects include changes in color, size and pose, as well as velocity and direction changes and creation (spawn) events for particles. They are driven by information extracted from the audio track of the played video, such as frequency spectrum, detected beat and onset events, pitch in form of the dominant frequency and overall volume, as described below. Space-filling floating particles (1.11) initially move with constant speed in parallel direction towards the user. They respond to audio signals by changing their brightness and velocity with respect to the volume, resulting in flashing and pulsing movements with respect to the played music, which in turn causes the sensation of a pulsing movement of the user.

Other particles (1.12, 1.13, 1.14) are spawned when a certain threshold of volume of selected frequency was exceeded, or change their movement direction based on detected pitch. Frequency bars (1.9) in the shape of rays may be positioned around the video canvas (1.1), each representing a fraction of the human perceivable frequency spectrum. Their length as well as brightness is controlled by the intensity of the corresponding frequency extracted from the audio track. In a similar manner, frequency bars (1.10) are displayed on the platform (1.4) under the user (1.2).

All of the above mentioned effects respond to visual and acoustic information derived from the video and audio track of the displayed video in order to integrate the video into the virtual world. The system is designed so that the effects originate from the video, such that the video content builds up the virtual world around the user. Realtime fusion of these effects assures a seamless blending of the 2D and 3D space.

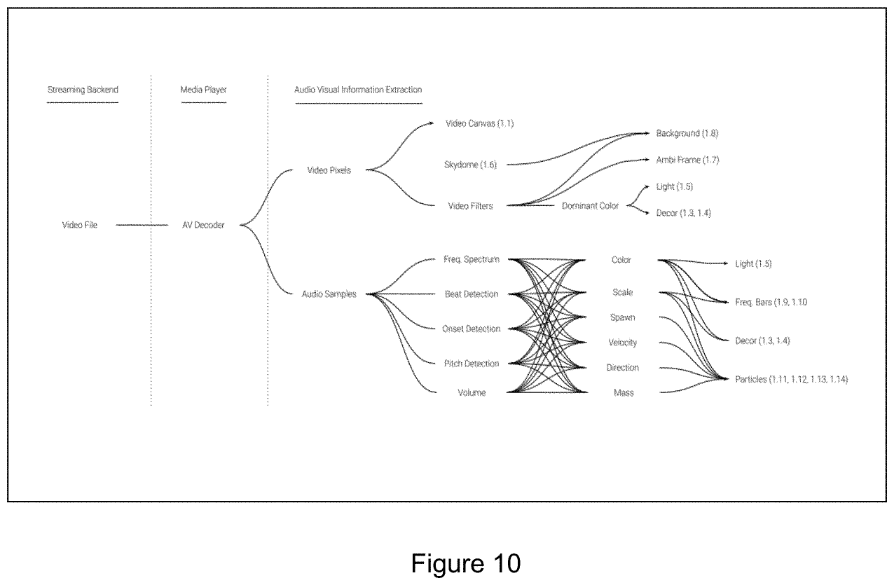

Audio visual information extraction from the video stream may be done in real time while playing the video stream on the user's playback device. One example of the overall processing pipeline is outlined in FIG. 10. The video file may be downloaded from the streaming backend by the media player and decoded on the playback device. At this point, the pipeline splits into two paths, one for visual data working on the video pixels and one for audio data working on audio samples. The video pixels may be directly copied as texture onto the video canvas (1.1). They further may be processed by a number of filters. The first is a down-scale and blur filter, which is implemented through the mipmap function of the graphics hardware on the playback device. It reduces the resolution of the video image and blurs it at the same time. The resulting pixels are then added to the skydome (1.6) texture and projected onto the background (1.8) in the virtual world. An additional filter process is applied to blend the seams, caused by projection, with their neighboring pixels. The resulting pixels are further used to create groups of pixels near the edge. These are copied into the texture that is mapped on the ambi frame (1.7). By setting the texture projection coordinates accordingly, the pixel colors appear to be stretched across texture plane achieving the desired ambilight effect. Finally, all reduced pixels are evaluated to find the most dominant color among them, which is then applied to the scene light (1.5) and decor virtual objects (1.3, 1.4).

The audio samples may be used in a number of different audio analysis algorithms in order to extract distinct features in the currently played music. The frequency spectrum may be computed with the forward Fast-Fourier-Transform using a Blackman window with a width of 2048 samples resulting in relative amplitudes with a frequency resolution of 10.7 Hz (with a sampling rate of 44100 Hz) within the human perceivable range. The spectrum may further be reduced to 128 frequency bands while preserving a sufficiently equal distribution between bass and treble. The results are a series of timestamps at which rhythmic event have been detected. Similarly, onset detection results in a series of timestamps at which discrete sound events occur. Pitch detection attempts to detect the perceived height of a musical note. Preferably, the algorithm is based on a Fourier transform to compute a tapered square difference function and spectral weighting. Finally, the RMS (root-mean-square) may be computed for the set of audio samples representing the effective volume at the given time.

The results of the audio analysis are mapped to various properties of the objects in the virtual environment. These include color, scale, pose, velocity, direction and mass. Each mapping is applied with respect to certain parameters that control the influence on the properties. Color is used by the scene light (1.5), the frequency bars (1.9) and virtual objects for the decor (1.3, 1.4). Scale is used to drive the length of the frequency bars (1.9, 1.10) and size of the virtual frame (1.3) around the video canvas (1.1). Spawn emits particles (1.12, 1.13, 1.14), while velocity, direction and mass control the impulse vector and momentum of particles (1.11, 1.12, 1.13, 1.14) respectively.

Optionally, audio information extraction can be performed in a pre-processing phase on the streaming backend in the cloud. In this case, the audio track is decoded and copied from the video file and the same audio analysis algorithms as in the real time analysis are applied. Resulting data is saved in a binary file stored next to the video file. If the media player detects that real time audio analysis is not possible on the playback device, then the pre-processed data is downloaded from the backend server and used for the visual effects.

Preferably, the present invention does not modify the content of the original video in any way. Instead, it extracts information from the played video and audio tracks to enhance the virtual environment automatically without the need to author such content for each video. With that being said, modification of the original content is also within the spirit and scope of the present invention. The combination of all these elements create a unique user experience for watching 2D concert videos (or the like) within an immersive virtual environment. The user feels much more included and connected with the presented concert than can be achieved with traditional methods.

In alternate embodiments, the immersive experience (e.g., the creation and movement of objects in 3D space, etc.) is not only based on the video and audio tracks of the original content (e.g., the 2D video, etc.), but may also be based on ambient data (e.g., location, temperature, lighting, humidity, altitude, barometric pressure, etc.) and/or biometric data from the user. This biometric data may include, but is not limited to, oxygen levels, CO2 levels, oxygen saturation, blood pressure, breathing rate (or patterns), heart rate, heart rate variance (HRV), EKG data, blood content (e.g., blood-alcohol level), audible levels (e.g., snoring, etc.), mood levels and changes, galvanic skin response, brain waves and/or activity or other neurological measurements (e.g., EEG data), sleep patterns, physical characteristics (e.g., height, weight, eye color, hair color, iris data, fingerprints, etc.) or responses (e.g., facial changes, iris (or pupil) changes, voice (or tone) changes, etc.), or any combination or resultant thereof.

For example, the speed at which objects move through 3D space, changes in texture, color, and/or size, or the nature of the object itself (e.g., stars, hearts, fireworks, etc.), could be based at least in part on biometric data from the user, such as their heart rate. For example, a faster heart rate could result in objects moving faster through 3D space. As well, or alternatively, certain aspects (e.g., speed, texture, color, object type, etc.) could be based on an emotion (e.g., happiness, anger, surprise, sadness, disgust, fear, admiration, etc.) or state (e.g., sleepy, healthy, tired, exhausted, sick, confused, intoxicated, etc.) of the user, which may be entered by the user (e.g., via a voice command, depressing at least one button, etc.) (i.e., self-reporting data) and/or determined based on biometric data from the user (e.g., sensed using at least one sensor) (e.g., pulse oximeter, EKG device, EEG device, video camera, microphone, etc.).

For example, if the user's hear rate goes up when a performer goes on stage, that could be an indication of admiration, and the system may present a plurality of hearts within the 3D space. By way of another example, if a video camera observes the user smiling (e.g., via facial recognition, etc.), that could be an indication of happiness, and objects within the 3D space (or the 3D space itself) may change to a more sensitive, positive color (e.g., pink, etc.). Obviously, other responses to emotion and/or state are within the spirit and scope of the present invention. By analyzing the original content (video and/or audio) and information derived from the user (e.g., via biometric data), a personalized immersive experience can be provided.

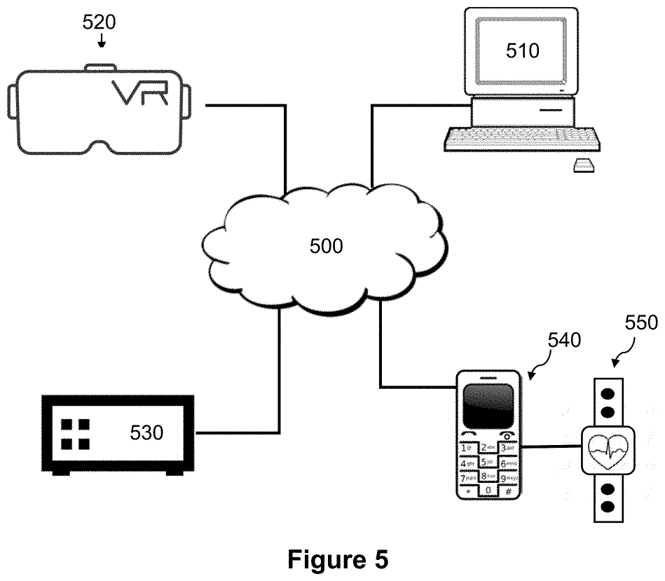

As shown in FIG. 5, a biometric device 550 (e.g., smartwatch or other wireless or wired device that includes at least one biometric sensor) may be in communication with a computing device 540, such as a smart phone, which, in turn, is in communication with at least one computing device 530, such as a set-top box, via a wireless communication channel 500 (e.g., wide area network (“WAN”), local area network (“LAN”), Wi-Fi, Bluetooth, etc.). Alternatively, the smart phone 540 may communicate with the set-top box 530 via at least one wired connection (not shown). This would allow, for example, the set-top box 530 to take user information (e.g., biometric data, emotional state, physical state, mental state, etc.) into account in creating and/or modifying the immersive 3D space and/or objects included therein. Alternatively, such information could be provided directly to the VR headset 520, allowing the headset 520 to take such information into account. Those skilled in the art will appreciate that such information should be provided to the device that is responsible for (or has the capability of) creating and/or modifying the 3D space and/or objects included therein.

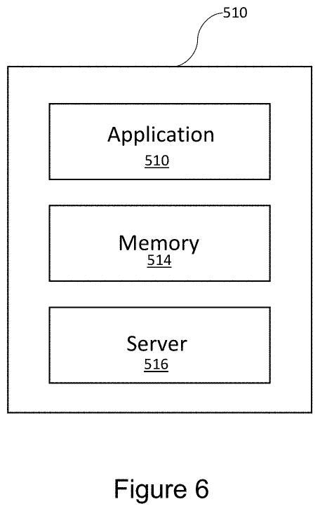

In one embodiment, as shown in FIG. 5, the original content may be streamed or downloaded from a host device 510 via the Internet. In this embodiment, the 3D immersive space and/or objects included therein may be created and/or modified by the host device 510, the set-top box 530, the VR headset 520, or any combination thereto. In this embodiment, as shown in FIG. 6, the host device 510 may include at least one server 516 (e.g. for communicating with the smart phone 540, set-top box 530, and/or VR headset 520), at least one application 510 (e.g., configured to perform a series of steps, as set forth herein (e.g., streaming video, creating 3D content, etc.)), and a memory device 514 (e.g., for storing original content, biometric data, corresponding 3D content, computer code for performing a series of steps, as set forth herein, etc.).

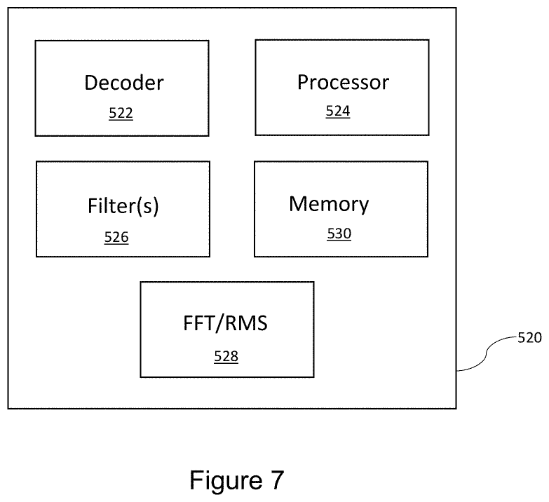

As shown in FIG. 7, the set-top box 530 may include a decoder 522 (e.g., for decoding video/audio signals from the host device, etc.), a processor 524 (e.g., for processing the decoded signals (e.g., using various filters, algorithms, etc.), etc.), a memory 530 (e.g. for storing processed data, computer code for performing a series of steps, as set forth herein, etc.), and if the set-top box 530 is responsible for creating and/or modifying the 3D space or objects included therein, at least one filter 526 (e.g., down-scale filter, blur filter, etc.) and at least one device 528 capable of performing at least one algorithmic computation (e.g., FFT, RMS, etc.). It should be appreciated that the present invention is not limited to the components shown in FIGS. 6 and 7, and fewer, additional, and/or different components are within the spirit and scope of the present invention. For example, the set-top box 520 may further includes at least one transceiver for receiving 2D/3D data and providing the same.

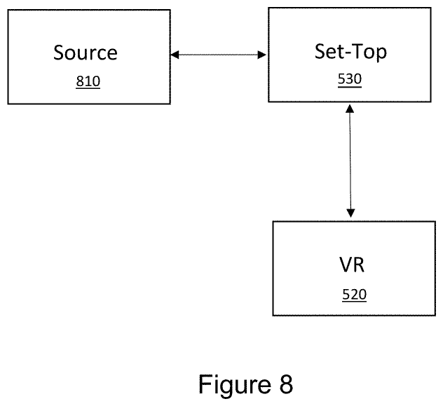

In an alternate embodiment, as shown in FIG. 8, the set-top box 530 may in communication (e.g., hard wired, etc.) with a source 810 (e.g., DVD player, cable box, satellite box, Roku player, etc.) and in communication (e.g., wirelessly, etc.) with a VR headset 520. In this embodiment, the original content is provided by the source 810, and the 3D space and/or objects included therein are created and/or modified by the set-top box 530 and/or the VR headset 520. This creation and/or modification can be done in real-time or beforehand, depending on when the original content is made available to the applicable device. This is in contradistinction to the embodiment shown in FIG. 5, where the original content is (preferably) provided by the host device 510. In this embodiment, the creation and/or modification of the 3D space and/or objects included therein may be performed beforehand (previously) and stored on the host device 510. Unless the creation and/or modification is being performed by the set-top box 530 and/or VR headset 520, in which case it is performed either in real-time or before-hand, depending on when the original content is made available to the applicable device. Obviously, combinations of the foregoing are also within the spirit and scope of the present invention. By way of example, the original content may come from a local source 810 and the 3D content may be generated and provided by the host device 510.

It should be appreciated that the present invention is not limited to the configurations shown in FIGS. 5 and 8. For example, in either embodiment, there may not be a need for a set-top box 530 if the VR headset 520 is configured to receive, process (if necessary), and display content (e.g., pre-recorded 2D video, computer-generated objects, etc.). Thus, for example, with respect to FIG. 5, the VR headset 520 may be configured to communicate directly with the host device 510 via a wide area network (WAN), such as the Internet (e.g., via a modem, router, etc.), thereby alleviating the need for a set-top box 530. In this embodiment, either the host device 510 or the VR headset 520 would be responsible for the computer-generated content (e.g., the creation and/or modification of the 3D immersive space and/or objects included therein). With respect to FIG. 8, the VR headset 520 may be configured to communicate directly with the source 810 via a wired (or wireless) connection (e.g., LAN, Bluetooth, Wi-Fi, etc.), thereby alleviating the need for a set-top box 530. In this embodiment, either the source 810 or the VR headset 520 would be responsible for the computer-generated content. Alternatively, an alternate device (not shown) could be responsible for the computer-generated content, with pre-recorded 2D video and computer-generated content stored together (as a single file or separate files linked together) (e.g., on the source 810, the host device 510, etc.).

The means and construction disclosed herein are by way of example and comprise primarily the preferred and alternative forms of putting the invention into effect. Although the drawings depict the preferred and alternative embodiments of the invention, other embodiments are described within the preceding text. One skilled in the art will appreciate that the disclosed apparatus may have a wide variety of configurations. Additionally, persons skilled in the art to which the invention pertains might consider the foregoing teachings in making various modifications, other embodiments, and alternative forms of the invention.

Therefore, the foregoing is considered illustrative of only the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. It is, therefore, to be understood that the invention is not limited to the particular embodiments or specific features shown herein. To the contrary, the inventor claims the invention in all of its forms, including all modifications, equivalents, and alternative embodiments which fall within the legitimate and valid scope of the appended claims, appropriately interpreted under the Doctrine of Equivalents.

What is claimed is:

1. A method for providing a user with an immersive, three-dimensional (3D) experience of pre-recorded two-dimensional (2D) video content, wherein said immersive, 3D experience is provided via a Virtual Reality (VR) headset having a 3D viewing space, comprising:
receiving said pre-recorded two-dimensional (2D) video content;
presenting said pre-recorded 2D video content to said user in a background of said 3D viewing space, said 2D video content being substantially centered in said 3D viewing space;
using said pre-recorded 2D video content to generating at least one computer-generated object, wherein at least a shape of said computer-generated object is based on information extracted from said pre-recorded 2D video content;
presenting said computer-generated object to said user in said background of said 3D viewing space; and
moving said computer-generated object from at least said background of said 3D viewing space to a foreground of said 3D viewing space to provide said user with said immersive, 3D experience of said pre-recorded 2D video content.

2. The method of claim 1, wherein a color of said computer-generated object is further based on said information extracted from said pre-recorded 2D content.

3. The method of claim 1, wherein movement of said computer-generated object from said background of said 3D viewing space to said foreground of said 3D viewing space is further based on said information extracted from said pre-recorded 2D video content.

4. The method of claim 1, wherein said shape of said computer-generated object is based on at least an image extracted from said pre-recorded 2D video content.

5. The method of claim 2, wherein said color of said computer-generated object is based on at least a color extracted from said pre-recorded 2D video content.

6. The method of claim 3, wherein said movement of said computer-generated object from said background of said 3D viewing space to said foreground of said 3D viewing space is based on at least a sound extracted from said pre-recorded 2D video content.

7. The method of claim 6, wherein said sound comprises at least one of frequency, pitch, beat, and volume.

8. The method of claim 1, wherein said computer-generated object is a 2D object.

9. The method of claim 1, wherein said computer-generated object is a 3D object.

10. The method of claim 1, wherein at least one of said shape, color, and movement of said computer-generated object is based on ambient data, said ambient data comprising at least one of location, temperature, lighting, humidity, altitude, barometric pressure, date, and time.

11. The method of claim 1, wherein at least one of said shape, color, and movement of said computer-generated object is based on biometric data of said user.

12. The method of claim 1, wherein said step of using said pre-recorded 2D content to generate at least one computer-generated object is performed in real-time, after said step of receiving said pre-recorded 2D video content, but before said step of presenting said pre-recorded 2D video content to said user in a background of said 3D viewing space.

13. A system for providing a user with an immersive, three-dimensional (3D) experience of pre-recorded two-dimensional (2D) video content, comprising:
a virtual-reality (VR) headset configured to present content to a user via a 3D viewing space; and
a set-top box configured to:
receive said pre-recorded 2D video content;
present said pre-recorded 2D video content in a background of said 3D viewing space;
use said pre-recorded 2D video content to generate at least one computer-generated object, wherein at least a shape of said computer-generated object is based on information extracted from said pre-recorded 2D video content;
presenting said computer-generated object in said background of said 3D viewing space; and
moving said computer-generated object from said background of said 3D viewing space to a foreground of said 3D viewing space to provide said user with said immersive, 3D experience of said pre-recorded 2D video content.

14. The system of claim 13, wherein said set-top box is further configured to use said information extracted from said pre-recorded 2D content to determine a color of said computer-generated object.

15. The system of claim 13, wherein said set-top box is further configured to use said information extracted from said pre-recorded 2D content to control movement of said computer-generated object.

16. The system of claim 13, wherein said set-top box is further configured to use at least an image extracted from said pre-recorded 2D video content to generate said shape of said computer-generated object.

17. The system of claim 14, wherein said set-top box is further configured to use at least a color extracted from said pre-recorded 2D video content to determine said color of said computer-generated object.

18. The system of claim 15, wherein said set-top box is further configured to use at least a sound extracted from said pre-recorded 2D video content to control said movement of said computer-generated object.

19. A method for providing a user with an immersive, three-dimensional (3D) experience via a Virtual Reality (VR) headset having a 3D viewing space, comprising:
presenting 2D video content to said user in said 3D viewing space;
using said 2D video content to generating at least one computer-generated object, wherein at least a shape of said computer-generated object is based on information extracted from said 2D video content;
presenting said computer-generated object to said user in said 3D viewing space; and
moving said computer-generated object from at least said background of said 3D viewing space to a foreground of said 3D viewing space to provide said user with said immersive, 3D experience.

20. The method of claim 19, wherein said 2D video content is presented in said background of said 3D viewing space.
